(19) United States
(12) Patent Application Publication
(10) Pub. No.: US 2008/0212679 A1
(43) Pub. Date: Sep. 4, 2008

(54) Motion estimation with dual search windows for high resolution video coding

(76) Inventors: Meng-Chun Lin, Jhubei City (TW); Lan-Rong Dung, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,072

(22) Filed: Feb. 29, 2008

(30) Foreign Application Priority Data
Mar. 2, 2007 (TW) 096107195

(51) Int. Cl. H04N 7/26

(52) U.S. Cl. 375/240.16; 382/236; 375/E07.124

(57) ABSTRACT

A memory-efficient motion estimation technique for high-resolution video coding is proposed. The main objective is to reduce the external memory access, especially for limited local memory resource. The reduction of memory access can successfully save the notorious power consumption. The key to reduce the memory access is based on center-biased algorithm in that the center-biased algorithm performs the motion vector searching with the minimum search data. While considering the data reusability, the proposed dual-search-windowing approaches use a secondary windowing as an option per searching necessity, by which the loading of search windows can be alleviated and hence reduce the required external memory bandwidth, without significant quality degradation.

### FIELD OF THE INVENTION

The present invention is related generally to motion estimation for video coding and, more particularly, to a motion estimation method and system with dual search windows for high-resolution video coding.

### BACKGROUND OF THE INVENTION

Motion estimation (ME) has been notably recognized as the most critical part of video compression, such as MPEG standards and H.26x. It tends to dominate the computational and hence power requirements. As the demand for high-resolution, high-quality video system increases, the implementation of motion estimation is becoming more costly and power-consuming. Among the hardware components of motion estimation, the on-chip memory is the one that dominates power consumption and cost. Because the on-chip memory size is too small to store a high-resolution frame, typically, an external memory such as DRAM, is used to store the frame, and then the frame is cut into a plurality of units with smaller size, for example 16×16 Macro-Block (MB), for being transferred to the on-chip memory. Accordingly, there always exists a tradeoff between the external memory bandwidth and on-chip memory size. The less the on-chip memory is used in motion estimation, the higher the external memory bandwidth is required. There are three factors that affect the tradeoffs: the data reuse mechanism, the size of search window, and the efficiency of external memory access. The first two factors can be exploited at the architecture level while the last can be improved in the DRAM controller.

In the past decade, various algorithms have been proposed to improve the performance of motion estimation in terms of compression ratio and computational cost; however, very few works present solutions for data reusability while analyzing the required external memory bandwidth. The Full-Search Block Matching (FSBM) algorithm with Sum of Absolute Differences (SAD) is the most popular criterion for motion estimation because of its considerably good quality. It is particularly attractive to those who require extremely high quality. However, the full search algorithm needs high computational load and large memory size which are a major problem in the implementation of motion estimation.

To reduce the computational complexity of FSBM, researchers have proposed various Fast Block-Matching Algorithms (FBMAs), by either reducing the number of search steps or simplifying the calculation of error criterion. The former is categorized as the center-biased algorithms, and the latter as the criterion-simplifying algorithms. By combining step-reduction and criterion-simplifying, some researchers proposed two-phase algorithms to balance the performance between complexity and quality. It has been shown that these fast algorithms can significantly reduce the computational load with little quality degradation. The center-biased algorithms are good for reducing the external memory bandwidth, while the center-biased algorithms, which are motivated by statistical observation show that most of Motion Vectors (MVs) are centered around (0,0) and, hence, only a small portion of the search window needs to be accessed most of the time. For high-resolution applications, this nice feature can help to reduce the external memory bandwidth and the local memory requirement.

Therefore, it is desired a motion estimation system and method for high-resolution video coding to efficiently reduce the external memory bandwidth without significant quality degradation.

### SUMMARY OF THE INVENTION

An objective of the present invention is to provide a motion estimation method and system with dual search windows for high-resolution video coding.

Another objective of the present invention is to provide a padding method for motion estimation.

According to the present invention, a novel windowing technique, called dual-search-windowing (DSW), for center-biased motion estimation algorithms is proposed. The DSW requires smaller on-chip memory than full search-windowing while maintaining high data reusability that significantly reduces the external memory bandwidth requirement. The DSW comprises a primary windowing and a secondary windowing. The primary windowing is necessary for all Motion Vector (MV) searches and the secondary windowing is only called for when needed. The primary windowing is sliding with macro-block changing, so each move only requires an update of a single slice. This leads to a high degree of reusability. When the center-biased algorithm moves outside the primary window, the secondary window will be loaded. Although the secondary window is not be reused for its occasional occurrence, thanks to the center-biased algorithm, the secondary windowing is seldom needed and the impact on external memory bandwidth requirement is low.

Since the center-biased algorithms realize MV search with the least data search, it helps to reduce the external memory access and in turn to efficiently reduce unnecessary power consumption. The primary window only cover the most motion vectors around the center, and thus has a size much smaller than that of a FSBM search window, so as to reduce the required on-chip memory size.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a flowchart of motion estimation using DSW algorithm;

FIG. 2 is an architecture of motion estimation with dual search windows;

FIGS. 3 and 4 schematically illustrate a padding algorithm;

FIG. 5 illustrates a primary windowing with single MB (Type 1);

FIG. 6 illustrates a primary windowing with two horizontal MBs (Type 2);

FIG. 7 illustrates a primary windowing with two vertical MBs (Type 3);

FIG. 8 illustrates a primary windowing with four MBs (Type 4);

FIG. 9 shows a windowing strategy for the case when both PMV and MV are in a primary window;

FIG. 10 shows a windowing strategy for the case, given a PMV in a primary window, when the MV searching reaches the boundary of the primary window;

FIG. 11 shows a windowing strategy for the case when a PMV is out of a primary window;

FIG. 12 shows a case for sizing of secondary window when both PMV and MV are within a primary window and a secondary window is not needed;

FIG. 13 shows a case for sizing of secondary window when a PMV is located in a primary window and the tracking of MV reaches the boundary of the primary window;

FIG. 14 shows a case for sizing of secondary window when a PMV is out of a primary window and the MV search is not returning into the primary window; and

FIG. 15 shows a case for sizing of secondary window when a PMV is out of a primary window and the MV search can go into the primary window when two sub-windows are overlapped.

### DETAIL DESCRIPTION OF THE INVENTION

The center-biased motion estimation algorithms are developed based on the observation that most of motion vectors are located near the center-point of the search window. For example, in cases of Diamond Search (DS) and Small Diamond Search (SDS), more than 98% MVs are located within ±32 search range. Hence, ±32 search range can be used for a primary window to save the external memory access. When a motion vector is out of the primary window, a secondary window is loaded for further search.

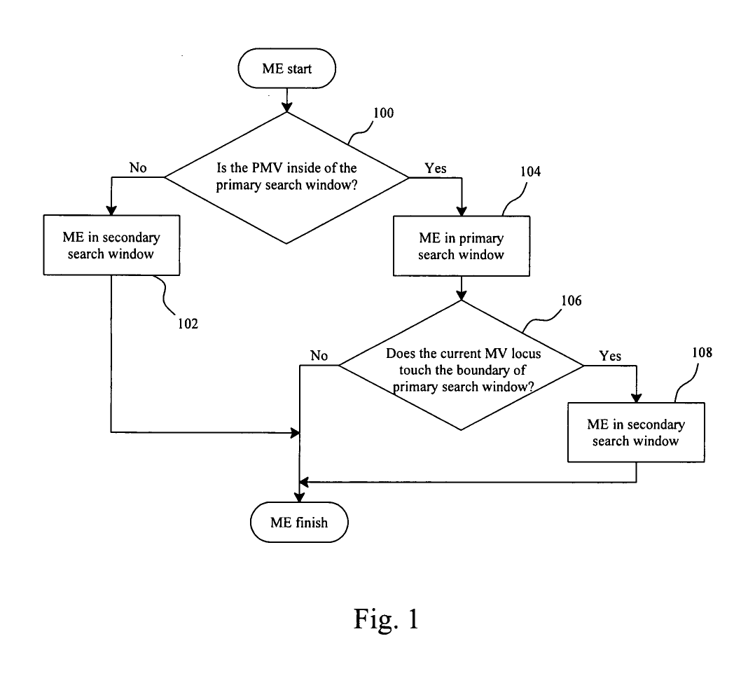

FIG. 1 provides a flowchart of motion estimation using DSW algorithm. The step 100 is to determine whether a Predicted Motion Vector (PMV) is inside of a primary window or not. The PMV is used to determine an initial search point. If the PMV is not inside of the primary window, then a secondary search window is loaded in the step 102, and motion estimation is performed in the secondary window. The ME finishes after the step 102. If the PMV is inside of the primary window, the primary window is loaded for performing motion estimation in the step 104. Then, the step 106 is used to determine whether or not the current MV locus touches the boundary of the primary search window. If it is not the case, the ME finishes; otherwise, a secondary search window is loaded to perform motion estimation in the step 108, and then the ME finishes.

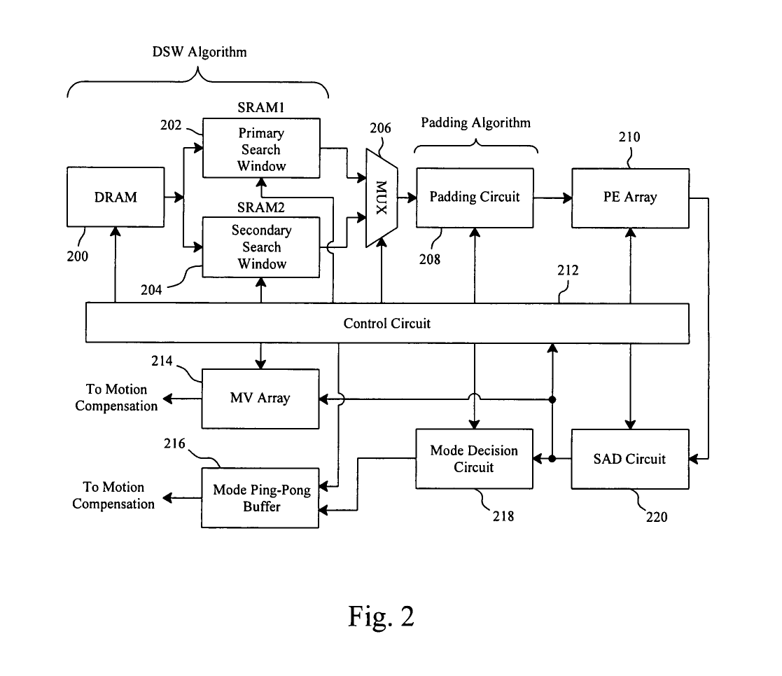

FIG. 2 provides an architecture of motion estimation with dual search windows, in which an external memory 200 is used to store frames, and a control circuit 212 controls on-chip memories 202 and 204 to access a primary search window and a secondary search window from the external memory 200. The control circuit 212 also controls a multiplexer 206 to transfer the primary window to a padding circuit 208 so that the control circuit 212 can direct the padding circuit 208 to pad the primary window with a padding algorithm if it is necessary. The primary window performs the MV search through a Processing Element (PE) array 210 and a SAD circuit 220. If the initial search point of a motion vector is outside of the primary window or the tracking of MV search is out of the primary window, the SAD circuit 220 triggers a signal to command the control circuit 212 to load the secondary window from the on-chip memory 204. After the destination of the MV is found, the related data are transferred to an MV array 214 and a mode decision circuit 218. The mode decision circuit 218 transfers the related data to a mode ping-pong buffer 216 after it determines a mode. At last, motion compensation is carried out according to the outputs of the MV array 214 and the mode ping-pong buffer 216.

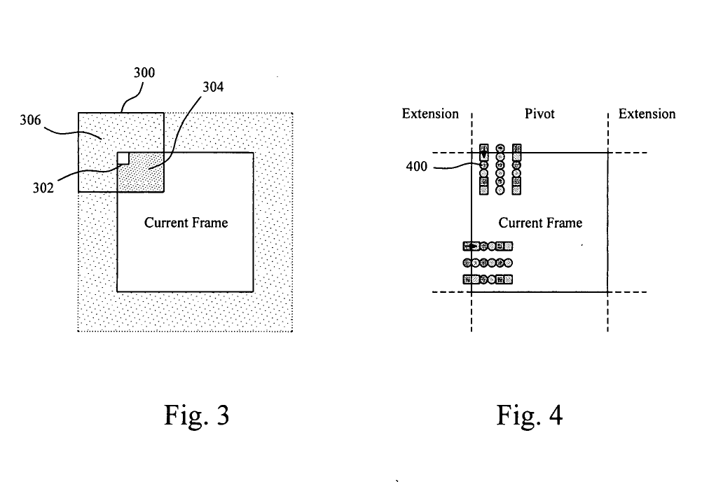

FIGS. 3 and 4 illustrate a flowchart of padding algorithm. In FIG. 3, block 300 is a full search window, block 302 is the current MB, block 304 represents the search window data from a previous frame, and block 306 represents the search window data from padding. As shown in FIG. 3, when the current MB 302 needs to be searched in the full search window 300, basically, all the data in the full search window 300 are completely transferred from the external DRAM to and stored in the internal SRAM. If the full search window 300 goes outside of the current frame, as shown by the block 306, generally, padding is used to generate the block 306 by reproducing and extending. Then data of the block 306 and the block 304 contained in the current frame are completely transferred from the external DRAM to and stored in the internal SRAM. However, the conventional padding always occupies additional bandwidth for transferring the reproduced extended data. Moreover, when performing motion estimation, if the locus does not go outside the block 304, the reproduced extended block 306 is not needed for MV search. Therefore, in view of saving bandwidth and the uncertainty of the search locus for MV, a novel padding algorithm is proposed, in which for handling each MB, merely the data of the search window contained in the current frame, namely that of the block 304, are seized first. Only when the tracking of the MV search goes out of the block 304, the extended block 306 outside the current frame is generated by reproducing through an internal logic circuit calculation.

FIG. 4 shows an embodiment of the padding according to the present invention. At the beginning of search, a leftmost pixel coordinate of each row in a search model 400 is used to determine whether or not it goes out of the current frame. If yes, the data of the row outside the frame will be calculated through logic calculation and be seized from a position corresponding to the current frame. If the leftmost pixel coordinate of each said row is within the current frame, the data of the row at the current position will be seized to be processed in the processing element of motion estimation.

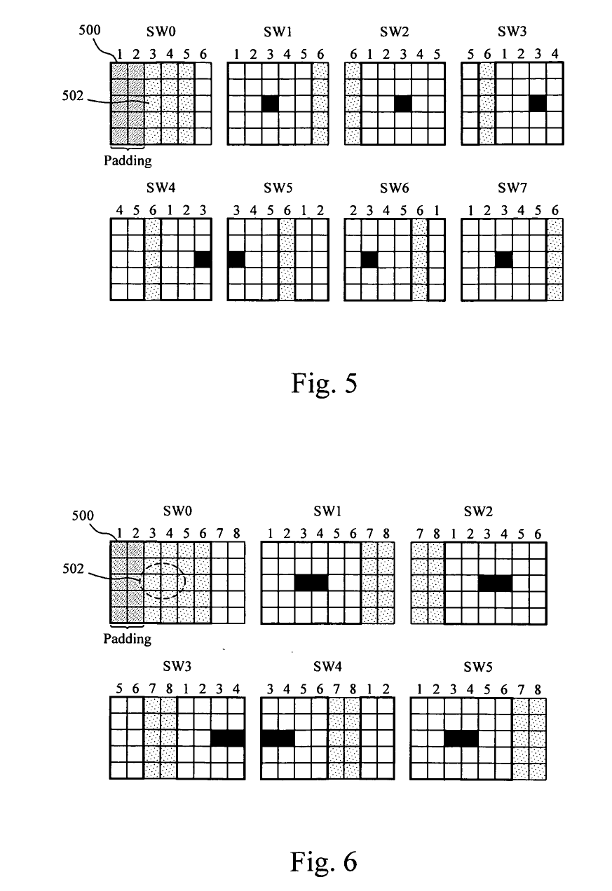

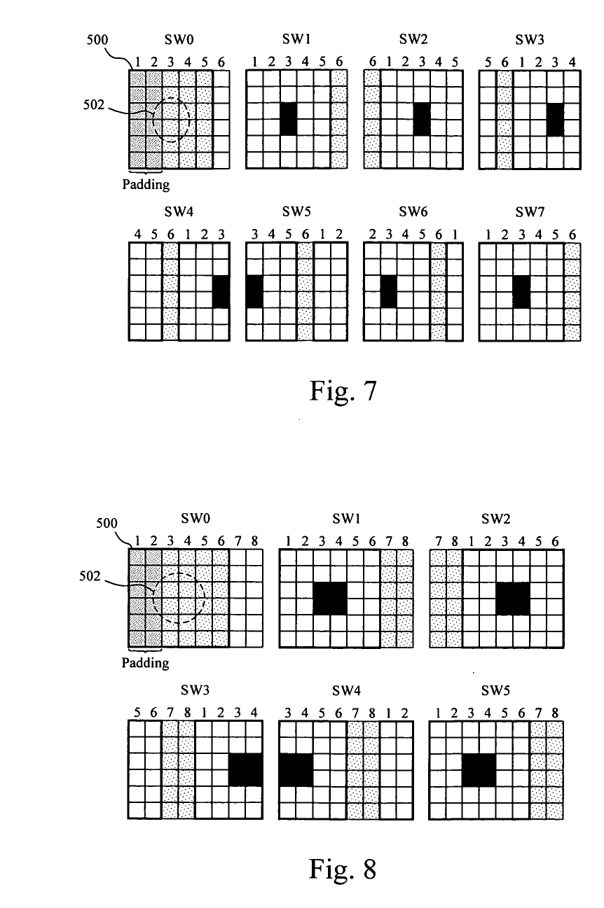

The primary windowing is used to load a smaller search window for most MV searches. For instance, given a DI video sequence, the typical search window size is ±64, and ±32 can be choused as the primary window because most MVs are within ±32. Note that the MB size in MPEG4/AVC is 16×16. Therefore, the local memory size can be ideally reduced by a factor of 81/25. FIG. 5 shows a primary windowing scheme with single MB. The bolded box 500 indicates the data in local memory and the centered square 502 is the current MB. SW0 is the initial windowing position, and SW1 to SW7 are window search steps. For the MB of SW1, three slices labeled by 3, 4 and 5 are first loaded, while the slices labeled by 1 and 2 are the padding data which is generated internally by the ME engine without consuming external memory bandwidth. When the MV search performs for the MB of SW1, the primary windowing simultaneously loads the slice 6 for the next MV search. The following steps of windowing show the parallel operations of MV searches and updates of slices. Comparing with full search windowing, the local memory size is reduced by a factor of 81/30 (or 2:7) and the external bandwidth requirement can be reduced by a factor of 9/5 (or 1.8). To increase the degree of reusability, one can process more MBs at a time because the data of the primary window can be used more than once for each data loading. However, the penalty is the increase of local memory size. FIGS. 6-8 illustrate the other primary windowing schemes with two or more MBs.

The primary windowing schemes shown in FIGS. 5-8 are referred to as Type 1, Type 2, Type 3 and Type 4, respectively. In each of the primary windowing period, the number of pixel access of each frame and the external memory bandwidth can be calculated and estimated according to the following equation

$${N}_{access , p} = Nf \times N 1 - 2 {m}_{x} \times Ny \times {\sum }_{i = 1}^{( N 1 - 1 )} i , \qquad [ Eq \text{-} 1 ]$$

where Nf is the frame pixel count, N1 is the regular access times of each pixel, mx is the number of the vertical pixels of target MB set for each primary windowing, and Ny is the number of the horizontal pixels of each frame. N1 and mₓ can be defined as

$$\begin{matrix}N 1 = \{ \begin{matrix}5 , & for Type = 1 , 2. \\ 3 , & for Type = 3 , 4.\end{matrix} & [ Eq \text{-} 2 ] \\ {m}_{x} = \{ \begin{matrix}16 , & for Type = 1 , 2. \\ 32 , & for Type = 3 , 4.\end{matrix} & [ Eq \text{-} 3 ]\end{matrix}$$

Based on the known two-step memory access mechanisms, three motion estimation algorithms for SDTV and HDTV applications are exemplarily illustrated. The first algorithm, named Fully-Expanding Dual-Search-Window (FEDSW), expands the search range to full search window when MV search reaches or locates beyond the boundary of the primary window. The FEDSW may have the least quality degradation, but it requires high memory bandwidth for loading the secondary windows to local SRAM. Since the center-biased ME seldom goes too far from the starting point, the secondary window can be set to a smaller size to save the external memory accesses. Hence, a second algorithm, called Fixed-Secondary-window Dual-Search-Window (FSDSW), is proposed. The FSDSW limits the size of the secondary window to cut the redundant external memory access and save local SRAM size. The range of the secondary window is determined by simulating test cases with full-sized search window. Given a range to cover most MV results, the FSDSW requires low memory bandwidth while the average quality loss is little. Nevertheless, its transient quality loss could be high for some high-motion clips. To deliver a quasi-static video quality, a third algorithm is further proposed to adaptively adjust the range of the secondary window. The third algorithm is called Variable-Secondary-window Dual-Search-Window (VSDSW). The VSDSW can adaptively adjust the size of the secondary window to keep the transient quality loss low and save unnecessary memory access. The following gives more detailed descriptions of these DSW algorithms.

### A. FEDSW

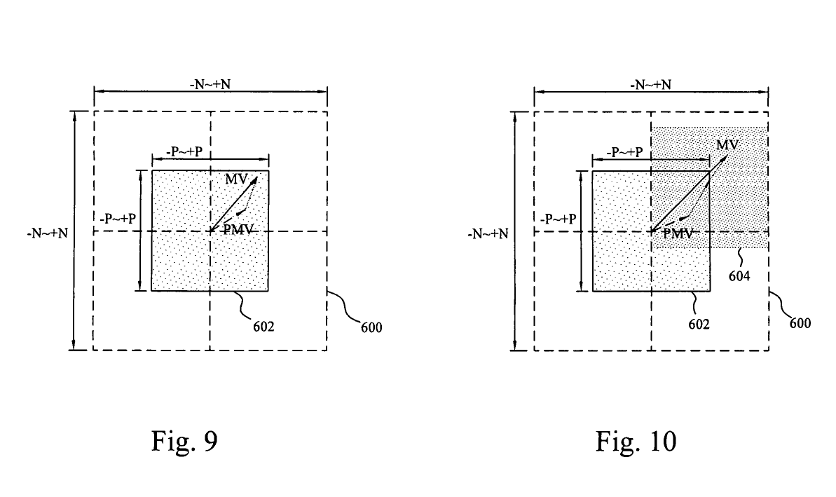

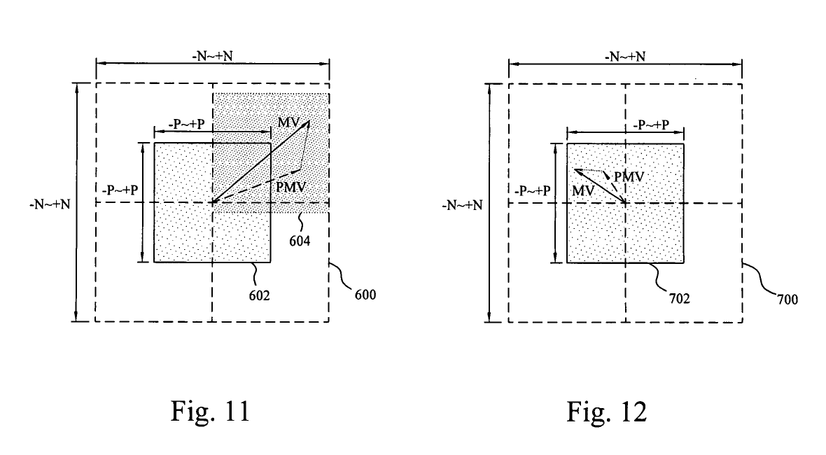

The FEDSW defines a primary window and four extra search windows, as shown in FIGS. 9-11, where (2N+1)×(2N+1), (2P+1)×(2P+1) and [(2N+1)/2]×[(2N+1)/2] indicate the ranges of total, primary and secondary window, respectively. In FIG. 9, the primary window 602 is at the center of the full search window 600 and the secondary windows 604 are located at four quadrants. During the ME process, a PMV is first calculated to decide the initial search point. If the PMV is located inside of the primary window 602, the FEDSW performs the MV searching within the primary window 602. As shown in FIG. 9, when both the PMV and MV are within the primary window 602, the secondary window will not be needed. When the search point reaches the boundary of the primary window 602, the secondary window 604 will be loaded to expand the search range for the right MV, as shown in FIG. 10. The secondary window 604 is selected according to in which quadrant the search point reaches the boundary. If the PMV is out of the primary window 602 at the beginning, the MV search will start in the secondary window 604, as shown in FIG. 11.

Although the FEDSW can efficiently decide whether or not a secondary window is used to find the candidate motion vector according to the direction of PMV or position of search point for each MB, the range of secondary window is still wide-ranging for high-resolution video sequences. For example, the range of original search window is [−64, +64] for horizontal and vertical directions, the primary window is [−32, +32] for both ones and the secondary window is quarter of original search window, namely [−32, +32]. The range of secondary window is the same as the one of primary window; however, based on statistical results, the candidate motion vectors of average 98.5% MB and ones of average 99.3% MB can be searched in the primary window ([−32, +32]) by using DS algorithm and SDS algorithm for six testing D1 video sequences respectively and therefore reducing the range of secondary window to efficiently saving memory access from DRAM to SRAM is necessary. To achieve this target, two optimal methods are further proposed to find the suitable secondary window, one is to support a fixed range of secondary window through the statistical analysis and the other can adaptively adjust the range of search window by using the curve fitting skill for different kinds of motion degree video sequences.

### B. FSDSW

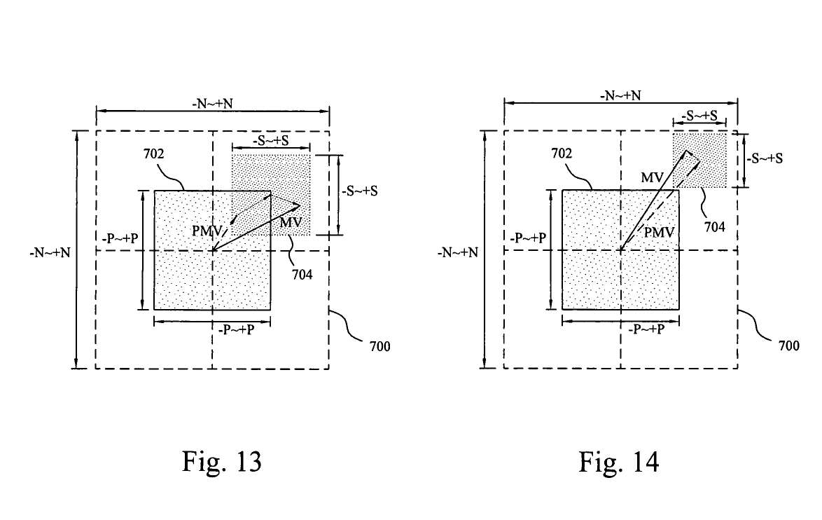

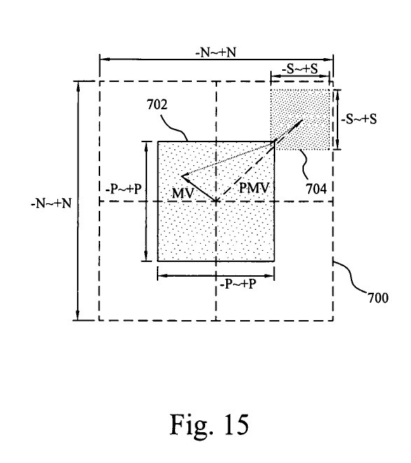

In FSDSW, the range of the secondary window is deterministic and fixed based on statistical results. FIGS. 12-15 show four cases for the secondary windowing, in which (2N+1)×(2N+1), (2P+1)×(2P+1) and (2S+1)×(2S+1) represent the overall range, primary window range and secondary window range, respectively. As shown in FIG. 12, the primary window 702 is also at the center of the full search window 700. Since the PMV is in the primary window 702 and the motion vector can be reached within the primary window 702, the secondary windowing 704 is not needed. However, if the search point touches the boundary of the primary window 702, the secondary windowing will be called and the search strategy becomes the second case, as shown in FIG. 13. Note that the motion vector will be searched until the search point reaches the boundary of the secondary window 704. The third and fourth cases occur when the PMV is out of the primary window 702, as shown in FIGS. 14 and 15. In the third case, the secondary windowing performs at the beginning while the primary window 702 is loaded. Since the primary window 702 and secondary window 704 are not overlapped, the MV searching is running within the secondary window 704 only, as shown in FIG. 14. If both windows 702 and 704 are overlapped, it will go with the fourth case, as shown in FIG. 15. For the last case, the MV searching will perform within the range covered by the primary and secondary windows 702 and 704.

### C. VSDSW

Instead of applying fixed size for the secondary window, VSDSW is developed to adaptively adjust the size of secondary window based on the SAD value of PMV for a specific MB. As shown in FIGS. 12-15, the motion estimation process starts after a PMV stage because the PMV can efficiently predict a good starting point for each MB. Hence, the range of MV searching is limited and depends on the SAD values of PMVs; the larger the SAD value, the larger the size of secondary window.

The required sizes of local memory for primary windowing are 60k bits (((5×6)×(16×16)×8)/1024), 80k bits (((5×8)×(16×16)×8)/1024), 72k bits (((6×6)×(16×16)×8)/1024), 96k bits (((6×8)×(16×16)×8)/1024) for single-MB, two-horizontal-MB, two-vertical-MB, and four-MB windowing techniques, respectively. For the secondary windowing, with the four-MB primary windowing, FEDSW requires 96 Kbits (((6×8)×(16×16)×8)/1024) local memory and VSDSW requires 50 Kbits (((5×5)×(16×16)×8)/1024). Comparing with the others, FSDSW requires the minimum local memory. From the analysis of memory bandwidth and local memory requirements, DSWs with single MB (Type 1) and two horizontal MB (Type 2) has the same bandwidth requirement while the latter requires more local memory than the former. Also, DSWs with single MB (Type 1), two vertical MB (Type 3) and four MB (Type 4) have the same requirement for memory bandwidth, while the latter two need larger local memory size than the former.

The above DSW algorithms may have minor quality degradation in some cases but can save much local memory and external memory bandwidth than conventional approaches. For the dynamic degradation, FSDSW may have worse transient degradation than FEDSW and VSDSW while the VSDSW is better than FEDSW. Therefore, VSDSW can have the best visual quality among the proposed algorithms. As the demand of high-resolution video applications increases, to solve the notorious power-consuming problem, the memory requirements have been the most important factors for the CODEC performance and quality. Given the limited local memory size, the present invention mainly focuses on the reduction of external memory bandwidth while the compression quality degradation is little. The reduction of memory bandwidth implies the save of power consumption. Three windowing algorithms are proposed for center-biased motion estimation and take the advantage of minimizing the required data access in the center-biased motion estimation. At the same time, taking the data reusability into account, the proposed windowing can significantly save the external memory bandwidth under rate-control mechanism.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A dual-search-windowing motion estimation method for high-resolution video coding, comprising the steps of:
determining a range for a primary window from a full search range according to a statistical material of motion vector occurrence positions;
determining an initial point for starting a motion vector search with a predicted motion vector; and
loading a secondary window for the motion vector search when the initial point or a tracking of the motion vector search is out of the range of the primary window.

2. The method of claim 1, further comprising the step of determining a range for the secondary window.

3. The method of claim 2, wherein the step of determining a range for the secondary window comprises the step of selecting a quarter of the full search range as the range of the secondary window.

4. The method of claim 2, wherein the step of determining a range for the secondary window comprises the step of determining the range of the secondary window according to a statistical material of a motion estimation in the full search range.

5. The method of claim 2, wherein the step of determining a range for the secondary window comprises the step of determining the range of the secondary window according to a sum of absolute differences of the predicted motion vector.

6. A dual-search-windowing motion estimation system for high-resolution video coding, comprising:
a first on-chip memory for storing a primary window loaded from an external memory;
a second on-chip memory; and
a circuit for determining to load a secondary window from the external memory to the second on-chip memory when an initial point or a tracking of a motion vector search is out of the primary window.

7. The system of claim 6, further comprising a padding circuit for padding the primary window and the secondary window with a padding algorithm.

8. A padding method for a motion estimation including loading a search window in a current frame for a motion vector search, the padding method comprising the steps of:
performing the motion vector search in a range of the search window contained in the frame when the search window goes outside the frame; and
when a tracking of the motion vector search is out of the frame, generating padding data outside the frame by reproducing and extending data at a boundary of the frame and performing the motion vector search accordingly.

9. The method of claim 8, further comprising the step of performing the motion vector search with a search model.

10. The method of claim 9, further comprising the step of determining whether or not the search model goes outside the frame according to a leftmost pixel coordinate in the search model.
